(19) United States
(12) Patent Application Publication
(10) Pub. No.: US 2023/0109693 A1
(43) Pub. Date: Apr. 13, 2023

(54) ASSEMBLY AND METHOD FOR DAMPING VIBRATIONS OF A STRUCTURE

(71) Applicants: BRANDENBURGISCHE TECHNISCHE UNIVERSITÄT COTTBUS-SENFTENBERG, Cottbus (DE); TECHNISCHE UNIVERSITÄT BERLIN, Berlin (DE)

(72) Inventors: Achim BLEICHER, Berlin (DE); Thomas SCHAUER, Berlin (DE); Yangwen ZHANG, Cottbus (DE); Wulf WULFF, Berlin (DE); Laurenz WERNICKE, Berlin (DE)

(73) Assignees: BRANDENBURGISCHE TECHNISCHE UNIVERSITÄT COTTBUS-SENFTENBERG, Cottbus (DE); TECHNISCHE UNIVERSITÄT BERLIN, Berlin (DE)

(21) Appl. No.: 17/911,590

(22) PCT Filed: Mar. 16, 2021
(86) PCT No.: PCT/DE2021/100258

§ 371 Date: Sep. 14, 2022

(30) Foreign Application Priority Data
Mar. 16, 2020 (DE) 10 2020 107 196.5

(51) Int. Cl. E04B 1/98; E04H 9/02; E04H 9/16; F16F 7/104

(52) U.S. Cl. CPC E04B 1/98; E04H 9/021; E04H 9/16; F16F 7/104; F16F 2222/08; F16F 2230/0023; F16F 2232/08; F16F 2230/08

(57) ABSTRACT

The invention relates to an assembly for damping vibrations of a structure (I), having a wall element (5a, 5b, 5c, 5d) to be fitted in a upright position, a casing element (Sa, Sb, Sc, 8d) and a damping device (22a, 22b, 22c, 22d), which is connected to the casing element (Sa, Sb, Sc, 8d) and to the wall element (5a, 5b, 5c, 5d) such that a relative movement between the wall element (5a, 5b, 5c, 5d) and the casing element (Sa, Sb, Sc, 8d) is transmitted to the damping device (22a, 22b, 22c, 22d). The damping device (22a, 22b, 22c, 22d) is designed to damp a vibrating movement of the wall element (5a, 5b, 5c, 5d) in a damping direction and is arranged such that the damping device is oriented substantially parallel to a surface of the wall element (5a, 5b, 5c, 5d). The invention further relates to a method for damping vibrations of a structure.

### BACKGROUND

Due to inner-city concentration, high-rise buildings, in particular so-called skyscrapers, are becoming taller and slimmer, which means that they are also becoming more susceptible to vibrations, which can be induced by wind or earthquakes, for example. Systems are usually installed that are tuned to the dominant natural frequencies of the high-rise building and counteract the natural vibrations. Such systems are primarily placed in the top of the skyscraper, where the amplitude of the first natural frequency can be efficiently reduced. If necessary, such systems can also be installed on lower floors.

Absorbers can be used for damping, which can also be referred to as vibration absorbers. Such absorbers consist of a spring-mass assembly. An absorber counteracts the system vibration and calms the system through a constant counter-vibration with minimal self-damping. Alternatively, vibration dampers can be used, which consist of a spring-mass damper assembly. A vibration damper itself behaves in a vibrating manner so that it counteracts the vibration of the system and absorbs the vibration energy supplied. For this purpose, the vibration damper is matched to the vibration behavior of the system to be damped.

Pendulum masses, roller-bearing masses or hydrodynamic damping via communicating tubes can be provided to damp building vibrations. In this case, it is common to install an additional mass for vibration damping, which can amount to several hundred tons and has to be removed via the supporting structure. This involves a large installation space, which often extends over several floors. Known are, for example, ball pendulums suspended at the top of a building inside the building or masses assembled over a surface area and parallel to the floor or ceiling between the stories, which vibrate parallel to the floor and perpendicular to the walls.

In order to use the existing mass and its construction space, a movable double facade can be used in which building vibrations are damped by the fact that the facade moves away from and towards the building structure. This results in a variable surface distance from the building structure to the vibration-damping moving element. In the event of wind excitation, the excitation forces are absorbed by the outer skin of the double facade, which can be moved orthogonally to the building, and their transmission to the building is thus reduced.

A complex load-dissipating solution is required for such systems. The kinematics must absorb high static vertical loads and at the same time be very dynamically mobile horizontally in order to achieve the goal of vibration damping. This means that the dynamically effective mass of the moving elements, which specifies the mass ratio of the moving elements and the mass of the building structure, is associated with an unfavorably high vertical load and is therefore structurally limited. The high static load of the dynamically effective element assembly results in high costs for the technical implementation, for example due to a multi-point bearing of a variable-distance guidance under high vertical load. This also limits the increase in mass of the vibration damping elements, which is desirable for favorable dynamic behavior. In the event of wind-induced vibration, the large surface area of the movable elements required for vibration damping is exactly in the direction of the wind excitation, so that vibration damping is only possible if this direct excitation is taken into account. The vibration damper effect for passive damping is reduced and additional semi-active or active vibration dampers and a special control of the active elements are required.

Document US 2019/345729 A1 discloses a system for reducing wind-induced vibration using a casing in which moveable panels are attached to an exterior facade of a building, skyscraper or other structure, by means of which the exterior shape of the facade is modified in order to reduce wind-induced vibration.

The present document KR 10-2018-0024329 A relates to a wall insulation system assembly with embossed panels. The layout has embossed panels installed in all directions on the front of insulation frames and horizontal materials to finish the wall. When vibration occurs in a building from an earthquake, the panels tilt within a certain range to alleviate the vibration occurring in the building or to absorb the vibration. The panels have an uneven outer surface.

A retrofitted structure for an existing building is described in the document EP 3 088 635 B1. The structure comprises a reinforcement frame including vertical frame members and horizontal frame members and vibration control members. The reinforcement frame is provided on an outer wall surface of an existing building with an overhang on the outer wall surface to encircle the overhang. The horizontal frame members are steel members. Vertical beam members and horizontal beam members are configured to couple the reinforcement frame and the outer wall surface, wherein a horizontal shear force acting on the reinforcement frame is transmitted to the existing building via the horizontal beam members and a vertical force resulting from an off-center bending moment and acting on the reinforcement frame is transmitted to the existing building via the vertical support members. The vertical frame members are steel members and the vibration control members are inserted between the vertical frame members.

### SUMMARY

The object of the invention is to provide an improved assembly and a method for damping vibrations in a structure, in which the disadvantages of the prior art are overcome and in particular efficient damping of vibrations in the structure using existing masses and with an improved supporting structure and load introduction is realized.

To achieve the object, an assembly for damping a vibration of a building according to claim 1 and a method for damping a vibration of a building according to claim 15 are created.

According to one aspect, an assembly for damping vibrations of a structure is provided, having a wall element to be mounted or fitted in an upright position, a casing element and a damping device. The damping device is connected both to the casing element and to the wall element in such a way that a relative movement between the wall element and the casing element is transmitted to the damping device. The damping device is configured to damp a vibrating movement of the wall element and is assembled in such a way that the damping direction is aligned substantially parallel to a surface of the wall element.

According to a further aspect, a method for damping vibrations of a structure is created. The method comprises providing a structure, arranging or assembling a wall element in an upright position on or in the structure, arranging a casing element on the wall element, arranging a damping device on the wall element and the casing element such that a damping direction of the damping device is aligned parallel to a surface of the wall element, connecting the damping device to the casing element and to the wall element in such a way that a relative movement between the wall element and the casing element is transmitted to the damping device, and damping a vibrating movement of the wall element transmitted to the damping device along the damping direction.

With the assembly, in particular, a vibration of a structure, for example a building, in particular a high-rise building, induced by wind excitation or earthquakes can be damped. For this purpose, the assembly can be used in or on the upper stories of a high-rise building. In particular, a vibrating movement of the casing element relative to the wall element is made possible along the damping direction, as a result of which a vibration of the wall element is damped by the damping device. As a result, a vibration of a structure, in particular a building on or in which the assembly is used, can be damped. In particular, the wall element can be a part of the structure or fixedly connected to it. For example, for the relative movement between the casing element and the wall element along the damping direction, a maximum stroke between 0.1 m and 2 m, preferably between 0.2 m and 1 m, more preferably between 0.3 m and 0.7 m, for example 0.5 m may be provided.

The surface of the wall element is the surface which extends over the main extent of the wall element. Thus, when looking at the wall element, the surface of the wall element is perceived as a wall. In this case, the wall element must be arranged in an upright position so that the surface of the wall element is not horizontal. The surface of the wall element can substantially run orthogonally to a base area of a structure, in particular a building, on or in which the wall element is assembled or will be assembled. Alternatively, the wall element may remain arranged in an at least partially oblique orientation while maintaining a generally upright alignment of the wall element. In particular, the wall element to be arranged in an upright position is not a floor element or ceiling element.

The wall element can be a wall of a structure, for example a building. In this case, the wall element can be arranged during the construction of the building, in that the wall of the building is erected. In this case, the wall can be formed by a structure which surrounds a free space which is delimited by the wall element. The wall can include elements, such as panes of glass, which close off the free space. For example, the wall can be formed by a supporting framework or a supporting structure, for example with elements running vertically, horizontally and/or diagonally, for example by the end faces of a floor and ceiling structure of a story of a structure and supporting elements running vertically, which enclose the free space to be closed by the facade. In this case, the wall element is arranged in an upright position by erecting the wall upright. Alternatively, the wall element can be an element which can be assembled or arranged on a wall of a structure in order to damp vibration of the structure. For example, the wall element can be an inner casing of a double casing, while the casing element is an outer casing of the double casing. The damping device can be connected directly or indirectly to the wall element, for example via a supporting structure. The casing element can be resiliently and/or oscillatingly mounted relative to the wall element.

The damping device can be assembled in such a way that the damping direction is further aligned substantially horizontally. In this case, the direction of damping is aligned both parallel to the surface of the wall element and horizontally. In particular, a horizontal alignment of the damping direction can mean an alignment parallel to a base area of a structure on or in which the wall element is or will be arranged, so that the damping direction indicates a lateral direction of movement of the relative movement between the wall element and the casing element. If necessary, the base area of the structure can be leveled compared to the surroundings of the structure.

A relative movement between the wall element and the casing element can be prevented along a direction perpendicular to the surface of the wall element. In this case, preventing a relative movement can mean preventing such a movement that goes beyond the play between components that is necessary for a corresponding design. For example, the casing element can be guided on the wall element or on a structure, for example by means of a rail system, which does not allow relative movement between the wall element and the casing element along a direction perpendicular to the surface of the wall element, except for a necessary amount of play. Alternatively, the damping device can be guided on the wall element or on the structure in such a way that relative movement between the wall element and the casing element along a direction perpendicular to the surface of the wall element is not permitted, except for a necessary play.

The damping device can be fixedly connected to the casing element or to the wall element. A fixed connection is to be understood here as a connection which does not permit relative movement between the fixedly connected elements. The fixed connection can be provided in a detachable manner, for example by screwing, hooking, or hanging in, or not (easily) detachable, for example by welding, soldering or gluing. The fixed connection can be provided directly between the elements or indirectly via connecting elements.

The damping device can (simultaneously) be fixedly connected both to the casing element and to the wall element. In this case, the two fixed connections may each be provided in a detachable or not (easily) detachable manner, or one of the connections may be provided in a detachable manner and the other of the connections may not be (easily) detachable. In this case, the casing element can be guided via the damping device on the wall element or on a structure, such that the casing element is connected to the wall element or the structure exclusively via the damping device. For example, the damping device can be connected to the wall element or the structure by means of a rail system.

As an alternative to a fixed connection, a non-fixed connection can be provided in which a relative movement between the connected elements is not (completely) prevented, wherein a relative movement between the wall element and the casing element is transmitted to the damping device. The damping device may be connected to the casing element and/or to the wall element in such a way that relative movement between the connected elements is prevented in at least one direction and made possible in at least one other direction. For example, a connection can be made by inserting a pin into an opening such that relative movement in an axial direction of the pin is allowed and is not allowed in directions perpendicular thereto. Alternatively or additionally, it can be provided that a connection is made by resting of one element on another, so that a movement along the damping direction in the positive direction of movement is transmitted by pressure and is not transmitted in the negative direction of movement, opposite to the positive direction of movement, since the connected elements move away from one another.

The damping device can comprise a damper. In particular, a spring-mass damper system can be formed in the assembly by means of the damping device. For this purpose, the damping device can include a spring element. The assembly can thus comprise a vibration damper. Dampers are known as such. For example, the damper can be a viscous damper or a magnetorheological damper.

In alternative configurations, the damping device can comprise a spring element and be designed without a damper. In particular, a spring-mass system can thus be formed in the assembly by means of the damping device. The assembly can thus include an absorber.

The mass of the spring-mass-damper system or the spring-mass system can be designed as a separate mass in the assembly. Alternatively or additionally, the mass can be a mass of the casing element and/or the damping device. In particular, the mass of the spring-mass system can be the total mass of the masses of the casing element and a separate mass and possibly other elements. Here, the damping device is configured to dampen the vibrating movement of the wall element through its effect in the spring-mass system or in the spring-mass damper system. In particular, the wall element can be fixedly connected to a structure and the damping device can form an absorber or vibration damper together with the casing element, which damps a vibrating movement of the structure that is transmitted to the wall element.

The damping device can comprise a drive device which is configured to generate a force which, for damping a vibrating movement of the wall element, counteracts a relative movement between the wall element and the casing element transmitted to the damping device or strengthens a relative movement between the wall element and the casing element transmitted to the damping device. In particular, a relative movement between the wall element and the casing element can be damped (i.e. counteracted) or strengthened in order to influence the relative movement in such a way that an exchange of energy between the wall element and the casing element caused by the relative movement leads to damping of the vibration of the wall element. In this way, active damping can be provided. For example, the drive device can include an electrical machine, in particular an electric motor, for example a stepping motor or a DC motor, or a hydraulic or pneumatic drive.

The damping device can comprise a generator device which is configured to convert kinetic energy of a relative movement between the wall element and the casing element, which is transmitted to the damping device, into another form of energy. The generator device can act as a damper for the damping device. In particular, the generator device can convert kinetic energy of the relative movement into an easily usable form of energy, for example electrical energy or chemical energy for storage in an accumulator, instead of converting it into heat. The generator device can include an electrical generator, which can be designed, for example, as a rotating electrical machine. The damping device can include a movement converter, which converts the linear movement along the damping direction into a movement suitable for the generator device, for example into a rotation or into a linear movement along another direction.

The damping device can include both a generator device and a drive device. For example, the damping device can comprise a combined generator-drive device, which is configured, in a first operating state, to convert kinetic energy of a relative movement between the wall element and the casing element that is transmitted to the damping device into another form of energy, and in a second operating state to generate a force, which can counteract or strengthen a relative movement between the wall element and the casing element for damping vibrations of the wall element transmitted to the damping device. For example, the combined generator-drive device can include an electrical machine that is designed both for motor operation and for generator operation. In this case, the damping device can comprise a movement converter which is configured for a conversion between the linear movement along the damping direction and a movement suitable for the generator drive device, in particular a rotation.

In contrast to a combined generator-drive device, a generator device can be embodied as an electric generator that is designed only for efficient generator operation, and a drive device can include an electric motor that is designed only for efficient motor operation. The damping device can include a generator device and a drive device, which are provided separately from one another.

The assembly can be configured to use energy provided by the generator device for operating the assembly. Energy converted by the generator can be used for self-sufficient operation of the assembly. For example, the energy converted by the generator can be used to adjust a damping effect of the damping device. Here, a damper of the damping device can be adjusted, in particular a resistance of the damper, for example as a function of a vibration state of the wall and casing element. In this way, efficient vibration damping of the wall element can be provided. In embodiments in which the damping device comprises both a generator device and a drive device, energy converted by the generator can be used alternatively or additionally to drive the motor device. In this case, the energy converted by the generator can be temporarily stored and later used to drive the motor device, particularly in embodiments having a combined generator-drive device. As a result, an autonomous operation of the assembly can be made possible without the supply of additional energy going beyond the vibration energy. In this way, more efficient vibration damping can be provided.

The assembly can comprise a sensor device which is configured to detect a movement of the wall element, a movement of the casing element or a relative movement between the wall element and the casing element. The sensor device can generate sensor data which indicate the movement of the wall element, the movement of the casing element or the relative movement between the wall element and the casing element. The sensor device can be configured to detect a movement of the wall element and a movement of the casing element and to generate the respective sensor data. Alternatively, several sensor devices can be provided, wherein one sensor device detects a movement of the wall element and generates corresponding sensor data and a further sensor device detects a movement of the casing element and generates corresponding further sensor data. The sensor data can be used to adapt a damping effect of the assembly, for example by means of semi-active control. As an alternative or in addition, active control based on the sensor data can be provided, for example by appropriate control of a generator device and/or a drive device.

The wall element can be an outer wall of a building and the casing element can be a facade element. Here, the outer wall of the building can be formed by an inner facade of a double facade and the casing element can be formed by an outer facade of the double facade. Alternatively, the exterior wall may be an integral wall of the building and the casing element may be a single element of a multi-part facade of the building.

In alternative embodiments, the wall element can be an interior wall of a building, and the casing element can be an element used for casing the interior wall. In this case, the inner wall of the building can be formed by an inner casing of a double casing and the casing element can be formed by an outer casing of the double casing.

The casing element can be a facade element, a shell element, an structure set in front of a wall or an integral part of a double facade. The casing element can be an element that is statically and/or dynamically effective in a structure.

The assembly can comprise a further casing element and a further damping device.

The further damping device can be connected both to the further casing element and to the wall element in such a way that a relative movement between the wall element and the further casing element along the damping direction is transmitted to the further damping device and the vibrational movement of the wall element is damped by means of the further damping device. Further casing elements and associated damping devices can be provided. As a result, a wall of a structure can be clad over a large area with a number of casing elements, all of which contribute to damping vibrations in the structure.

The casing element and the further casing element can be fixedly connected to one another. A fixed connection is to be understood here as a connection which does not permit relative movement between the fixedly connected elements. The fixed connection can be provided in a detachable manner, for example by screwing, hooking, or hanging in, or not (easily) detachable, for example by welding, soldering or gluing. The fixed connection can be provided directly between the elements or indirectly via connecting elements. Correspondingly, a fixed connection with further casing elements can also be provided. As a result, a vibration of the structure can be damped by cladding a wall of the structure with a plurality of casing elements, which vibrate as a single casing.

The further damping device can be connected both to the further casing element and to a further wall element to be mounted or arranged in an upright position in such a way that a relative movement between the further wall element and the further casing element is transmitted along a further damping direction to the further damping device and a vibrating movement of the further wall element is damped by means the further damping device, wherein the further damping device is arranged in such a way that the further damping direction is aligned substantially parallel to a surface of the further wall element. In this case, the further wall element can be arranged at an angle, for example a right angle, to the wall element. This can allow vibrations to be damped in different directions. In particular, damping of torsional vibrations of a structure in or on which the assembly is used can be provided. Alternatively or additionally, the wall element can be an outer wall and the further wall element can be an inner wall.

It can be provided that several casing elements and damping devices for vibration damping are arranged on different wall elements. It can be provided that several walls of a structure are cladded or encased with a plurality of casing elements, which all contribute to the damping of vibrations of the structure in different directions. The embodiments provided in connection with a plurality of casing elements and damping devices assembled on a wall element and the configurations provided in connection with casing elements and damping devices assembled on a number of wall elements can be provided individually or in combination. In particular, the outer walls on the upper stories of a structure can each be provided with a plurality of facade elements and damping devices over their entire surface in order to effectively damp vibrations of the structure.

A relative movement between the wall element and the casing element is preferably only permitted in the damping direction. In alternative embodiments, it can be provided that a relative movement between the wall element and the casing element is made possible in one or more further directions. In this case, it can be provided that the damping device is configured to damp a vibrating movement of the wall element in one or more further damping directions. Alternatively or additionally, one or more further damping devices assigned to the casing element can be provided, which are each configured to damp a vibrating movement of the wall element in one or more further damping directions, which can each be aligned substantially parallel to the surface of the wall element.

The components of the assembly can be adapted for a specific intended application. In particular, the damping device and the casing element, for example the mass of the casing element, and possibly other components can be adapted for an expected vibration behavior in a planned application. In this case, the wall element can be fixedly connected to a structure or be part of a structure whose vibrations are to be damped. For example, one or more of the factors mass of a structure whose vibrations are to be damped, stiffness of the structure, structural damping of the structure, natural frequencies of the structure, vibration amplitudes of the structure, height of the structure, cross-section of the structure, source of the expected vibration excitation, expected intensity of vibration excitation, frequency, in particular frequency spectrum, expected vibrations and amplitude of the expected vibrations may be taken into account. In the case of the factors which are determined by the structure, corresponding influences of the assembly or of parts of the assembly, in particular the wall element, may be taken into account.

In the method for damping a vibration of a structure, the order of the steps can vary in different embodiments. For example, the wall element can be a wall of the structure and can be arranged on or in the shell of the structure, for example. As a further alternative, the wall element can be arranged on or in the structure after the casing element and/or the damping device has been arranged on the wall element, for example the wall element, the casing element and the damping device can be arranged, as an assembled double casing with the wall element, on a wall of the structure. In both cases, the damping device can first be arranged on the casing element in order to subsequently arrange the damping device and the casing element on the wall element. Alternatively, the damping device can first be arranged on the wall element in order to then arrange the casing element on the wall element and the damping device. The respective connection of the damping device to the wall element and the casing element can take place directly after the corresponding arranging step or later, for example after the casing element and the damping device have been arranged.

In connection with the method, the embodiments described above in connection with the assembly for damping a vibration of a structure can be provided accordingly. In particular, the method can include arranging and connecting a plurality of wall elements, a plurality of casing elements and/or a plurality of damping devices.

### DESCRIPTION OF THE EMBODIMENTS

Further embodiments are explained in greater detail below with reference to the drawings. In the drawings:

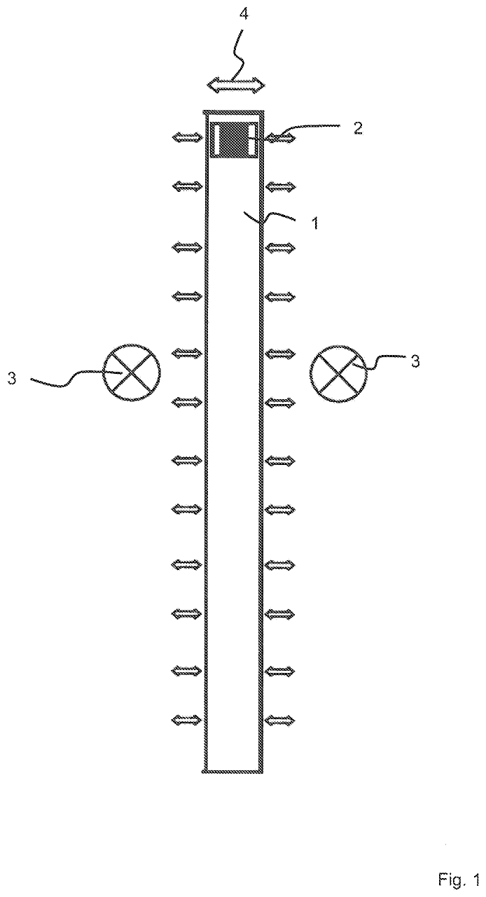

FIG. 1 is a schematic representation of a building with a known system for vibration damping;

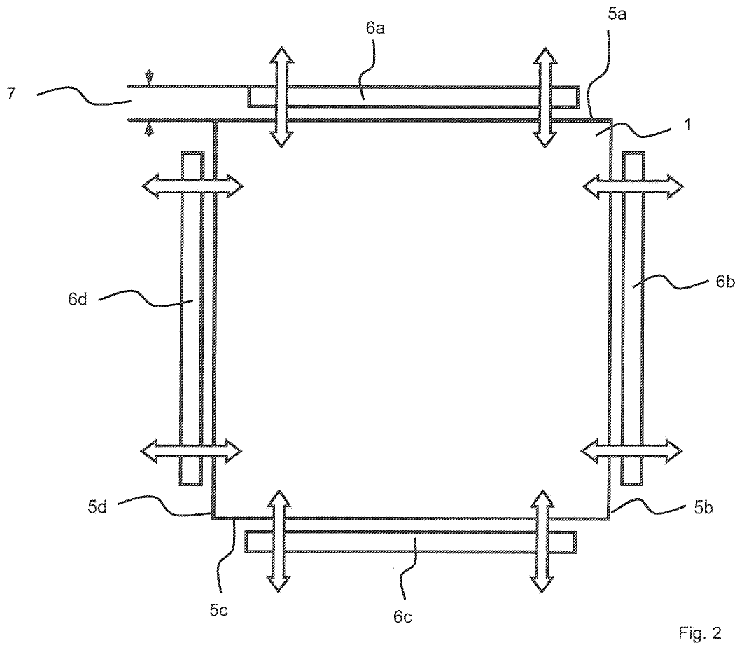

FIG. 2 is a schematic representation of another known system for vibration damping;

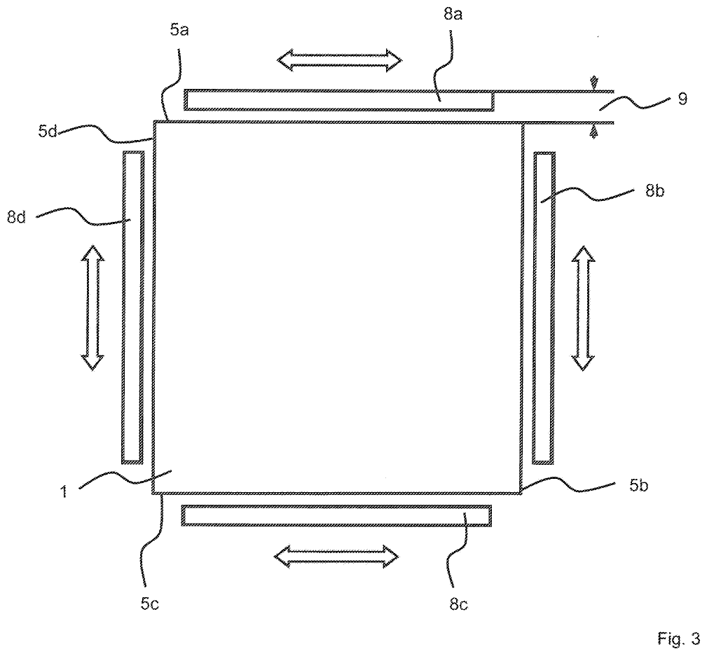

FIG. 3 is a schematic representation of an assembly for damping vibrations of a structure;

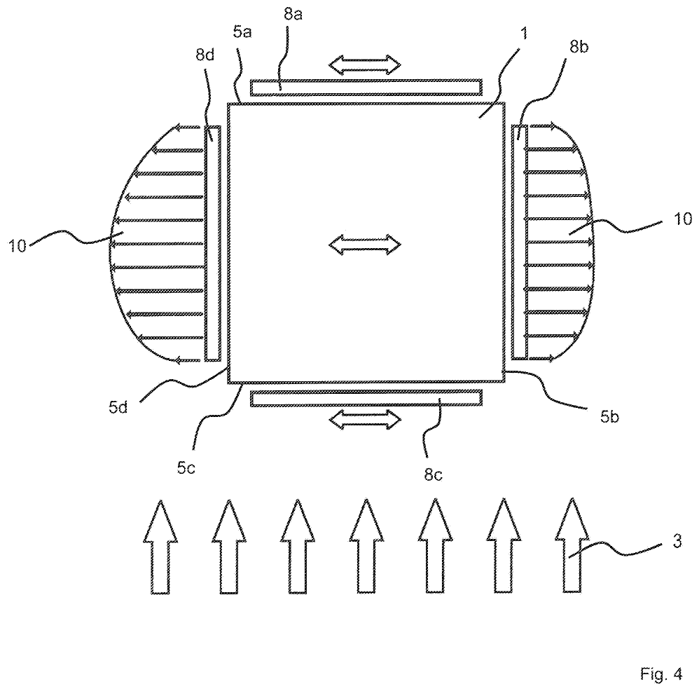

FIG. 4 is a schematic representation of the damping of wind-induced vibrations;

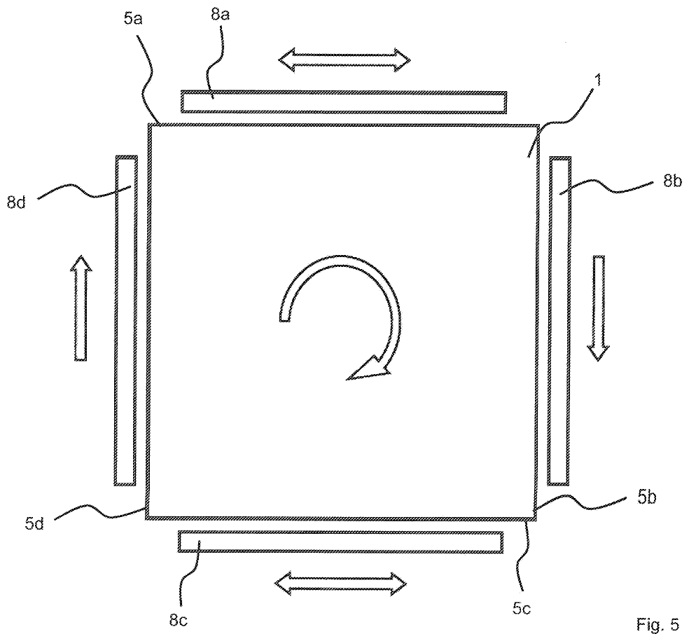

FIG. 5 is a schematic representation of the damping of torsional vibrations;

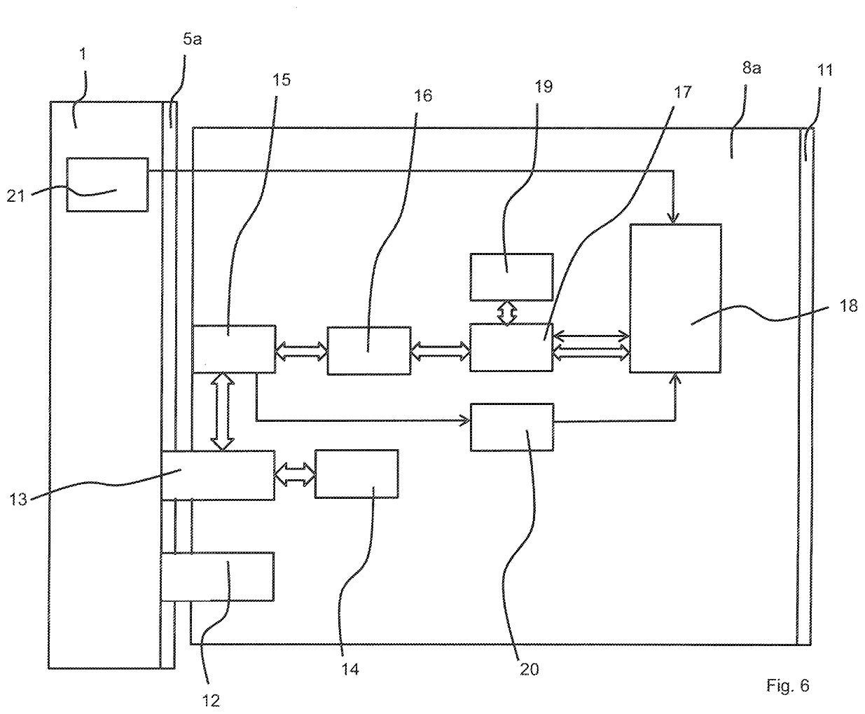

FIG. 6 is a schematic representation of a further assembly for damping vibrations of a structure;

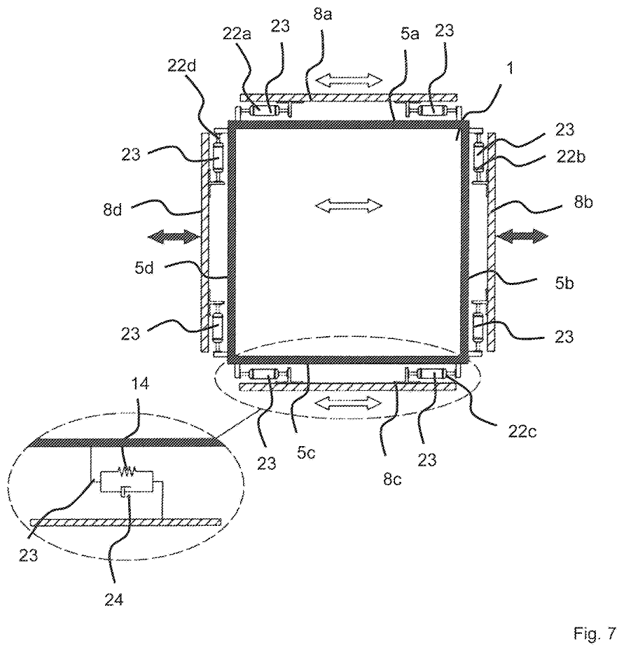

FIG. 7 is a schematic representation of yet another assembly for damping vibrations of a structure;

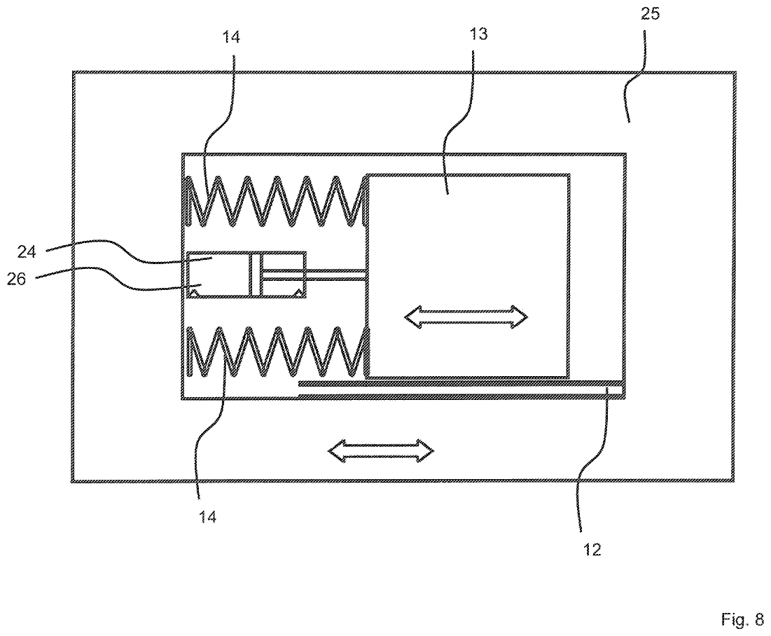

FIG. 8 is a schematic representation of a damping device; and

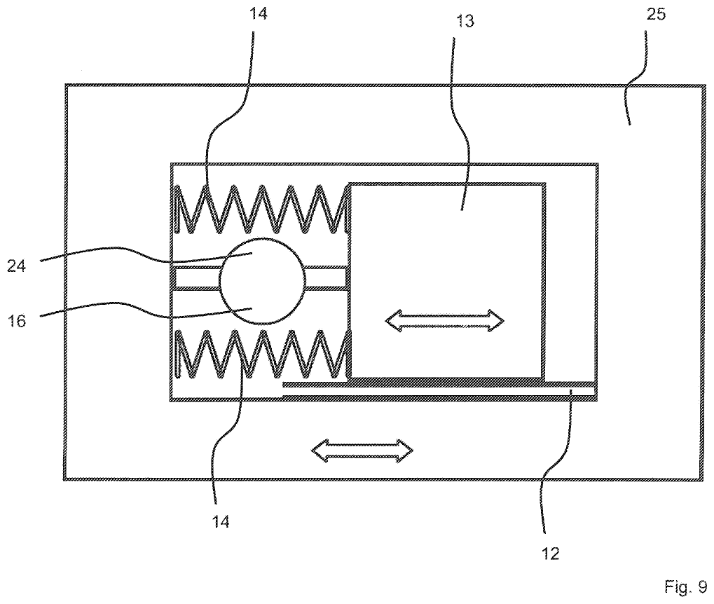

FIG. 9 is a schematic representation of a further damping device.

FIG. 1 shows a building 1, namely a slender high-rise building, with a known system for damping vibrations, which comprises a movably spring-mounted mass 2 in the top of the building 1. In the application shown in FIG. 1, the building 1 is excited to vibrate by the wind. The wind direction 3 of the exciting wind points into the plane of the drawing. The wind excitation occurs primarily through vortex shedding of the wind blowing past the building 1, which causes forces acting orthogonally to the wind direction 3. These forces cause the building 1 to vibrate transversely to the wind direction 3, which is indicated by arrows in FIG. 1. The building vibration leads to a relative movement of the mass 2 to the building 1 along the direction 4. This movement of the mass 2 counteracts the vibrations of the building 1 and damps them, an absorber being formed with the resiliently suspended mass.

FIG. 2 shows another system for damping vibrations. Facade elements 6a, 6b, 6c, 6d are resiliently mounted on outer walls 5a, 5b, 5c, 5d of the building 1 shown in a top view, with a variable distance to a respective outer wall 5a, 5b, 5c, 5d. Here, the outer walls 5a, 5b, 5c, 5d form inner facades of a double facade, while the facade elements 6a, 6b, 6c, 6d form associated outer walls of the double facade. In the event of vibrations, the facade elements 6a, 6b, 6c, 6d move relative to the building 1 perpendicularly to the surface of the respective outer wall 5a, 5b, 5c, 5d, so that a distance 7 between the facade elements 6a, 6b, 6c, 6d and the respective outer wall facade elements 6a, 6b, 6c, 6d changes. This is indicated by arrows in FIG. 2. In the case of vibrational excitation by wind, the exciting forces are absorbed by the facade elements 6a, 6b, 6c, 6d of the double facade, which can be moved orthogonally to the building, and their transmission to the building 1 is thus reduced.

The system according to FIG. 2 requires a complex, load-dissipating solution. The kinematics must both absorb high static vertical loads and at the same time be very dynamically flexible horizontally in order to achieve the goal of vibration damping. The dynamically effective mass of the movable facade elements 6a, 6b, 6c, 6d, which specifies the mass ratio of movable elements and the mass of the building structure, is also associated with an unfavorably high vertical load and is therefore structurally limited. At the same time, in the case of vibration excitation by wind, the movable facade elements 6a, 6b, 6c, 6d, which are required for vibration damping, lie with their large area exactly in the direction of the wind excitation, so that vibration damping is only possible taking this direct excitation into account. In particular, in the case of controlled vibration damping, such an excitation requires complex active control.

FIG. 3 shows an assembly according to the disclosure for damping vibrations of a structure, namely a building 1 in a top view of the building 1. Casing elements 8a, 8b, 8c, 8d are assembled on wall elements of the building 1. In the embodiment of FIG. 3, the wall elements are outer walls 5a, 5b, 5c, 5d of the building 1. The casing elements 8a, 8b, 8c, 8d can thus be understood as facade elements. The casing elements 8a, 8b, 8c, 8d are mounted in such a way that a vibrating movement opposite and parallel to the respective wall 5a, 5b, 5c, 5d is made possible, which is indicated by arrows in FIG. 3. In the embodiment of FIG. 3, the wall elements are aligned vertically. In alternative embodiments, the wall elements can have an at least partially oblique orientation, with a general upright orientation of the wall elements on the building 1 being retained. When the building 1 vibrates, the casing elements 8a, 8b, 8c, 8d move parallel to the respective outer wall 5a, 5b, 5c, 5d, wherein the respective distance 9 between the casing elements 8a, 8b, 8c, 8d and the corresponding outer wall 5a, 5b, 5c, 5d remains constant. In the example of FIG. 2, the relative movement is in each case a horizontal movement. In alternative embodiments, a relative movement can be provided in another direction of movement parallel to the corresponding outer wall 5a, 5b, 5c, 5d, for example perpendicularly or obliquely.

Due to the relative movement between the building 1 and the outer walls 5a, 5b, 5c, 5d on the one hand and the casing elements 8a, 8b, 8c, 8d on the other hand, a vibration-damping effect on the building is achieved. For this purpose, the casing elements 8a, 8b, 8c, 8d can be resiliently mounted in order to form a vibration absorber with each of the casing elements 8a, 8b, 8c, 8d. In addition, a respective damper can be provided in order to form a vibration damper with each of the casing elements 8a, 8b, 8c, 8d.

Due to the movement of the casing elements 8a, 8b, 8c, 8d parallel to the respective outer wall 5a, 5b, 5c, 5d, a constant, small distance between the movable vibration damping elements and the supporting structure can be made possible during the movement, so that a more reliable dissipation of vertical loads during the movement is possible. As a result, the provision of a smooth dynamic displacement movement parallel to the building structure is made possible by kinematics, as a result of which structural simplification and cost savings can be achieved. In addition, it can be made possible to provide both a high mass ratio of movable elements to the mass of the building structure and a large movement path, as a result of which the vibration damping can be positively influenced. In the case of vibration excitation by wind, the large surface area of the movable elements required for vibration damping is no longer in the direction of the wind excitation, which means that the movable structures can be relieved.

According to the embodiment of FIG. 3, the casing elements 8a, 8b, 8c, 8d are each locked in a direction perpendicular to the surface of the relevant outer wall 5a, 5b, 5c, 5d. For example, the casing elements 8a, 8b, 8c, 8d can be guided on a respective rail system on the outer wall 5a, 5b, 5c, 5d in question, which allows a relative movement to the building 1 in the respective direction illustrated by arrows in FIG. 3 and prevents relative movement in other directions.

FIG. 4 shows the assembly according to FIG. 3 in the case of vibrational excitation by wind. The wind 3 blowing past the building 1 leads to an excitation transverse to the wind direction 3 due to vortex shedding, wherein a load distribution 10 occurs on the casing elements 8b, 8d. This load is transmitted—by fixing the casing elements 8b, 8d in the direction perpendicular to the respective outer wall 5b, 5d—to the building 1 which is excited to vibrate, the direction of which is indicated by an arrow. The vibrations of the building 1 lead to a movement relative to the casing elements 8a, 8c in the direction of vibration, as indicated by arrows. The energy exchange caused by this movement between the wall element and thus the building on the one hand and the casing element and possibly elements movable with the casing element on the other hand leads to a damping of the building vibration.

Damping of torsional vibrations with the assembly according to FIG. 3 is shown in FIG. 5. Due to the assembly of the casing elements 8a, 8b, 8c, 8d, an opposing movement of the opposing elements leads to a torsional moment on the building structure, which can be coupled in as a countermeasure, for example by being independently excited by vibration and/or by an active movement of the corresponding casing elements 8a, 8b, 8c, 8d. According to FIG. 5, lateral vibrations of the building 1 are damped by a parallel relative movement of the casing elements 8a and 8c. At the same time, the casing elements 8b and 8d move in opposite directions, so that a torsional vibration of the building 1, indicated by a round arrow in FIG. 5, is damped.

FIG. 6 schematically shows another assembly for damping vibrations of a structure, namely a building 1. In this case, the casing element 8a forms a closed functional unit, the outside 11 of which is perceived as the outside of the facade of the building 1. To mount the casing element 8a on the building 1, a guide system 12 is used, which is hung in on the element underside and on the element upper side of the casing element 8a. A damping device is assembled on the casing element 8a in a cavity of the casing element 8a and is fixedly connected to the casing element 8a. The damping device is connected to the outer wall 5a by means of a movement transmitter 13 in the form of a pin to be fastened to the building 1. The pin transfers a relative movement between the wall element 5a of the building 1 and the casing element 8a to the damping device. In embodiments of the assembly, the damping device can be connected to the wall element and/or to the casing element 8a by hanging in a hook of the damping device on a corresponding element, for example another hook, of the wall element or the casing element 8a.

The relative movement is coupled to an internal spring element 14 of the damping device via the movement transmitter 13, whereby a spring energy flow is achieved for the thus vibratory system of spring element 14 and mass of the casing element 8a. Furthermore, a damping energy flow is forwarded via the movement transmitter 13 to a movement converter 15 of the damping device. For example, the motion converter 15 can be a linear-to-rotation converter transmission. The linear movement is converted with the movement converter 15 in such a way that a movement arises which is optimally suited for an electrical machine 16. For example, a rotational movement is provided by the movement converter 15, the speed of which is adapted to the electrical machine 16, which is designed as a rotating electrical machine. The electrical machine 16 can be operated as a motor or generator. Here, the electrical machine 16 acts as a damper. In generator mode, the electrical machine 16 converts the kinetic energy of the relative movement into electrical energy. During motor operation, the electrical machine generates a force or moment by converting electrical energy that is provided, which counteracts or amplifies the relative movement in order to damp the vibrations of the wall element and thus of the building. Power electronics 17 supplies the necessary energy for motor operation or changes the electrical load in generator operation, which decisively determines the damping behavior. For this purpose, the control signals required for this are calculated in a control unit 18 in real time, for example by means of estimation and control algorithms, and are transmitted to the power electronics 17. Electrical energy generated by the electrical machine 16 is fed into an electrical energy store 19 in a controlled manner and is then available, for example, for the autonomous operation of the control unit 18 and the power electronics 17 and for motor operation. A respective inertial sensor system 20, 21 in the casing element 8a and the building 1 is used to determine the time-variable system state. The inertial sensor system 21, which detects the acceleration of the building, is connected to the control unit 18 via a data link, for example a radio link.

In various configurations of the assembly for damping vibrations in a structure, the structure, in particular a building 1, can be designed with a double facade. For example, a so-called second-skin facade can be provided, which as the outer facade comprises the casing element 8a, 8b, 8c, 8d as an outer impact disk and its connection structure, to protect the wall element 5a designed as the inner facade and an intermediate sun protection against wind and weather. Such a double facade can also be referred to as an open-cavity facade (OCF). Room-high window sashes can be integrated into the interior facade, which can be partly (limited) opened for ventilation purposes and fully opened for inspection and cleaning work.

Alternatively, the double facade can be designed with a so-called closed-cavity facade (CCF), which is based on a closed double-shell facade that provides the casing element 8a, 8b, 8c, 8d. On the inside, the CCF can be double or triple glazed. A larger space can follow, which accommodates the sun protection and is limited to the outside by single glazing. Filtered dry air can also actively flow through the space, which can prevent the windows from fogging up. Due to such a multi-glazed, airtight structure, both a high level of thermal insulation and a high level of sound insulation can be achieved. In addition, due to the closed structure, contamination of the sun protection and its control components can be avoided, and a maintenance-free design can be achieved. Before being mounted on the wall element 5a, 5b, 5c, 5d, the facade elements can be completely prefabricated in the factory, as a result of which consistently high quality can be ensured.

In exemplary embodiments, a building 1 with side lengths of 20 m to 30 m and a height of 200 m to 300 m can be provided. For example, a building having a square cross-section with a side length of 12 m can be provided. Each floor of the building can have a height of 3.8 m. With these dimensions, 3 to 4 facade elements with a width of 3 m to 4 m can be placed per floor and per side. It can be provided that all casing elements 8a, 8b, 8c, 8d are fixedly connected per floor and side and move together. Alternatively or additionally, a vertical connection of casing elements 8a, 8b, 8c, 8d can be provided over two or more stories. Provision can be made here for only one damping device to be provided for casing elements 8a, 8b, 8c, 8d connected in this way. A casing element 8a, 8b, 8c, 8d can thus be formed with a plurality of sub-elements. In this way, mechatronic components can be saved. Alternatively, a damping unit is provided for each of the connected casing elements 8a, 8b, 8c, 8d. In this case, the casing elements 8a, 8b, 8c, 8d can be completely prefabricated during production in the factory, as a result of which subsequent simple and reliable assembly can be ensured.

FIG. 7 shows yet another assembly for damping vibrations in a structure. The casing elements 8a, 8b, 8c, 8d are each fixedly connected to a damping device 22a, 22b, 22c, 22d, wherein each of the damping devices 22a, 22b, 22c, 22d comprises a plurality of vibration dampers 23 which are each fixedly connected to the associated casing element 8a, 8b, 8c, 8d. Each of the vibration dampers 23 comprises a spring element 14 and a damper 24. The damping devices 22a, 22b, 22c, 22d are each fixedly connected to an outer wall 5a, 5b, 5c, 5d of a building 1 by each of the vibration dampers 23 being fixedly connected to the relevant outer wall 5a, 5b, 5c, 5d. Due to the fixed connection of the vibration damper 23 both with the casing elements 8a, 8b, 8c, 8d and with the outer walls 5a, 5b, 5c, 5d, a respective relative movement between the casing elements 8a, 8b, 8c, 8d and the outer walls 5a, 5b, 5c, 5d is transferred onto the damping devices 22a, 22b, 22c, 22d, namely on the vibration damper 23. The vibration dampers damp a relative movement of the casing elements 8a, 8b, 8c, 8d parallel to the corresponding outer wall 5a, 5b, 5c, 5d and thus a vibration of the building.

FIG. 8 shows a schematic representation of a damping device. The damping device is connected to a wall element of a building (not shown) via a movement transmitter 13. Furthermore, the damping device is connected to a casing element by means of a connecting element 25 of the casing element. The casing element is fastened to the outer wall of the building and guided via a guide system 12, so that the casing element can only perform a horizontal movement parallel to the outer wall. In the illustrated embodiment, the guide system 12 comprises a plurality of rollers and a guide rail in order to guide the casing element via the connecting element 25 in a parallel-displaceable manner on the wall element in a manner that is smooth-running and safe with respect to all loads.

The damping device comprises two spring elements 14 and a damper 24. Thus, by means of the damping device and the mass of the moving components, a vibration damper is provided for damping vibrations on the building. In the embodiment shown, the damper is provided as a cylinder damper 26 which provides viscous damping. The damper acts purely passively, wherein the damping force depends on the speed.

FIG. 9 shows a further damping device. In contrast to the damping device according to FIG. 8, the damping device according to FIG. 9 has an electrical machine 16 as damper 24. The electrical machine 16 comprises a motor-generator assembly, which can actively damp vibrations of a structure both in generator mode and, using additional energy, as a motor. In the embodiment shown, the electrical machine 16 is a rotating electrical machine.

The damping device also comprises a movement converter 15 (not shown), which is designed as a transmission that converts a linear vibrating movement into a rotational movement. For example, the transmission for this purpose can be a form-fitting transmission, for example a rack and pinion gear, a ball screw or a toothed belt gear. The transmission can be designed for a very smooth function. In this way, in particular, energy loss that is required for the conversion of movement can be minimized. Such lost energy can be regarded as damping energy, which is not available for energy harvesting by means of the generator.

Instead of a conventional viscous damper, an electrical generator is therefore provided, which is connected to power electronics (not shown). With this combination, damping can be adjusted electrically, while at the same time energy can be obtained from the movement and temporarily stored in an energy store. This can enable autonomous operation of the damping device. The generator can be designed for very low nominal speeds. For example, the generator can also be configured for use when the first natural vibrations of a building are very low. The generator can be configured to supply voltages in the lower one-digit to two-digit volt range even at very low speeds. For example, a stepping motor in generator mode or a DC machine can be provided as the generator.

In general, when designing an assembly for damping vibrations in a structure, it can be provided that a model equation of an electrical machine is derived, with which different degrees of damping can be implemented in the electrical circuit. Different power-electronic circuit concepts can be provided, which enable the passive and semi-active operation of a mechatronic vibration damper. Various energy storage technologies can be used. Controllable power electronics connected to an energy store can be provided. For example, regulation by pulse width modulation (PWM) can be provided.

The features disclosed in the above description, the claims, and the drawings can be of relevance, both individually and also in any combination, for realizing the different embodiments.

1. Assembly for damping vibrations of a structure, comprising
a wall element to be mounted in an upright position;
a casing element and
a damping device, which is
connected both to the casing element and to the wall element in such a way that a relative movement between the wall element and the casing element transmitted to the damping device;
configured to damp a vibrating movement of the wall element along a damping direction; and
arranged such that the damping direction is aligned substantially parallel to a surface of the wall element.

2. The assembly according to claim 1, wherein the damping device is arranged in such a way that the direction of damping is further aligned substantially horizontally.

3. The assembly according to claim 1, wherein a relative movement between the wall element and the casing element along a direction perpendicular to the surface of the wall element is prevented.

4. The assembly according to claim 1, wherein the damping device is fixedly connected to the casing element or to the wall element.

5. The assembly according to claim 1, wherein the damping device comprises a damper.

6. The assembly according to claim 1, wherein the damping device comprises a drive device which is configured to generate a force which force, for damping a vibrating movement of the wall element,
counteracts a relative movement between the wall element and the casing element transmitted to the damping device, or
amplifies a relative movement between the wall element and the casing element transmitted to the damping device.

7. The assembly according to claim 1, wherein the damping device comprises a generator device which is configured to convert a kinetic energy of a relative movement between the wall element and the casing element transferred onto the damping device into another form of energy.

8. The assembly according to claim 7, configured to use energy provided by the generator device for operating the assembly.

9. The assembly according to claim 1, comprising a sensor device which is configured to detect a movement of the wall element a movement of the casing element.

10. The assembly according to claim 1, wherein the wall element is an outer wal1 of a building and the casing element is a facade element.

11. The assembly according to claim 1, comprising a further casing element and a further damping device.

12. The assembly according to claim 11, wherein the further damping device is connected both to the further casing element and to the wall element in such a way that a relative movement between the wall element and the further casing element along the damping direction is transmitted to the further damping device and the vibrating movement of the wall element is damped by means of the further damping device.

13. The assembly according to claim 12, wherein the casing element and the further casing element are fixedly connected to one another.

14. The assembly according to claim 11, wherein the further damping device is connected both to the further casing element and to a further wall element to be mounted in an upright position in such a way that a relative movement between the further wall element and the further casing element along a further damping direction is transmitted to the further damping device and a vibrating movement of the further wall element is damped by means of the further damping device, wherein the further damping device is arranged in such a way that the further damping direction is aligned substantially parallel to a surface of the further wall element.

15. Method for damping vibrations of a structure, comprising:
providing a structure;
arranging a wall element in an upright position on or in the structure;
arranging a casing element on the wall element;
arranging a damping device on the wall element and the casing element in such a way that a damping direction of the damping device is aligned parallel to a surface of the wall element;
connecting the damping device to the casing element and to the wall element in such a way that a relative movement between the wall element and the casing element is transferred to the damping device; and
damping a vibrating movement of the wall element transmitted to the damping device along the damping direction.
